(19) United States
(12) Patent Application Publication
(10) Pub. No.: US 2022/0215325 A1
(43) Pub. Date: Jul. 7, 2022

(54) AUTOMATED IDENTIFICATION OF CHANGED-INDUCED INCIDENTS

(71) Applicant: Kyndryl, Inc., New York, NY (US)

(72) Inventors: Omar Odibat, Cedar Park, TX (US); Sanjana Sahayaraj, Chennai (IN); Shahrukh Khan, Islamabad (PK); Alexandre Francisco Da Silva, Uberlandia (BR); Nadeem Malik, Austin, TX (US); Muhammad Faisal, Islamabad (PK)

(73) Assignee: Kyndryl, Inc., New York, NY (US)

(21) Appl. No.: 17/180,085

(22) Filed: Feb. 19, 2021

(30) Foreign Application Priority Data
Jan. 1, 2021 (PK) 40/2021

(51) Int. Cl. G06Q 10/06; G06F 16/28

(52) U.S. Cl. CPC G06Q 10/063114; G06F 16/285

(57) ABSTRACT

An embodiment includes determining if a new incident report of a new incident matches any resolved incident reports associated with resolved incidents. The embodiment performs a first classification operation on the new incident report to determine if the new incident report is likely to be similar to any resolved incident reports associated with resolved incidents. The embodiment also performs a second classification operation on the new incident report to generate a ranked list of changes that are likely to be similar to the new incident report. The embodiment outputs the ranked list of changes to an incident manager for evaluation, then receives an input representative of a selected change from among the ranked list of changes responsible for causing the new incident. The embodiment revises the new incident report to include a reference to the selected change.

### BACKGROUND

The present invention relates generally to a method, system, and computer program product for information technology service management. More particularly, the present invention relates to a method, system, and computer program product for automated identification of changed-induced incidents.

In the field of information technology (IT), entities that provide IT services typically implement some form of IT service management (ITSM) aimed at maintaining and improving IT services for customers. ITSM typically includes incident management among several other practice areas, such as change management, knowledge management, service level management, and many others. In the field of information technology (IT), a Request for Change (RFC) or simply “Change”, is defined as the addition, modification, or removal of anything that could have a direct or indirect effect on services. Incident management refers to a process for responding to an incident with the goal of restoring the service with minimal impact to users and business. In the field of incident management, an “incident” refers to an unplanned interruption or reduction in quality of an IT service, including a failure of a configuration item that has not yet impacted service.

An incident management tool is one supported by an incident ticket system (ITS), which is a software system that runs in an organization and keeps records referred to as “tickets” of malfunctions and/or an affected services. A ticket is a record that contains information about a failure or malfunction, as well as information concerning support interventions made by technical support or third parties on behalf of an end user who has reported an incident. Tickets can be automatically issued by monitoring systems when they recognize a degradation of the IT system.

There has been considerable research related to the correlation of trouble ticket/symptoms/events for Incident and Problem Management and fault diagnosis.

### SUMMARY

The illustrative embodiments provide for pattern analysis for automated identification of changed-induced incidents. An embodiment includes determining if a first new incident report of a first new incident matches any resolved incident reports associated with resolved incidents. The embodiment also includes performing a first classification operation on the first new incident report to determine if the first new incident report is likely to be similar to any resolved incident reports associated with resolved incidents. The embodiment also includes performing a second classification operation on the first new incident report to generate a ranked list of executed changes that are likely to be similar to the first new incident report. The embodiment also includes outputting the ranked list of changes to an incident manager for evaluation. The embodiment also includes receiving an input representative of a selected change from among the ranked list of changes responsible for causing the first new incident. The embodiment also includes revising the first new incident report to include a reference to the selected change. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a cloud computing environment according to an embodiment of the present invention;

FIG. 2 depicts abstraction model layers according to an embodiment of the present invention;

FIG. 3 depicts a block diagram of an example service infrastructure that includes an ITS system in accordance with an illustrative embodiment;

FIG. 4 depicts a block diagram an example ITS in accordance with an illustrative embodiment;

FIG. 5 depicts a block diagram of an example operation by the match detection module in accordance with an illustrative embodiment;

FIG. 6 depicts a block diagram of an example repeated incident detection module in accordance with an illustrative embodiment;

FIG. 7 depicts a block diagram of an example new linkage module in accordance with an illustrative embodiment; and

FIG. 8 a flowchart of an example process for providing automated identification of changed-induced incidents in accordance with an illustrative embodiment.

### DETAILED DESCRIPTION

Enterprise networks, systems, and other related processes may utilize software and hardware resources, often implemented on multiple, inter-connected devices, to conduct activities or otherwise perform the activities of various enterprise operations. Software updates involving changes may give rise to unexpected issues and may lead to an incident being generated in response to such issues. To handle these events, many service providers implement some form of IT service management (ITSM) that includes an incident ticket system (ITS).

However, within an ITS, there can coexist different categories of tickets (also referred to herein as “incident reports”) without any explicit relationship with each other. While information about failed or disrupted services and/or resources can co-exist, this information can be scattered over the system. One detrimental result is that the connection/relationship between a failed resource and a malfunctioning service cannot be realized without considerable effort. Processing these kind of requests is generally handled by an incident manager, but even for an experienced incident manager these requests are time-consuming and resource intensive. There can be substantial overlap between requests, for example, as numerous requests may be submitted by different people in relation to a same problem. While a connection between an incident and a cause may possibly be realized manually, in a system of any appreciable size the manual approach can be time consuming, expensive and inherently unreliable.

The present embodiments recognize that, due to the complexity of trying to link incident reports to responsible hardware or software changes, many incidents often propagate as problem code is built upon before being recognized as problematic. As a result, it may not only be time consuming to identify problematic code, but by the time it is discovered, the degree to which it has become integrated and built-upon may make a resolution considerable more complex than if the problematic code had been discovered earlier. Therefore, present embodiments leverage machine-learning technology to evaluate incident reports and changes to identify responsible code or significantly narrow the list of candidate changes that an incident manager must review to identify code responsible for an incident.

The illustrative embodiments address and solve this technical problem by providing for automated identification of changed-induced incidents in accordance with an illustrative embodiment. In a particular embodiment, an ITS provide for real-time automated identification of changed-induced incidents.

In an embodiment, an ITS determines if a first new incident report of a first new incident matches any resolved incident reports associated with resolved incidents. The ITS performs a first classification operation on the first new incident report to determine if the first new incident report is likely to be similar to any resolved incident reports associated with resolved incidents. The ITS also performs a second classification operation on the first new incident report to generate a ranked list of changes that are likely to be similar to the first new incident report.

In some embodiments, the ITS outputs the ranked list of changes to an incident manager for evaluation. The ranked list presents the incident manager with a significantly narrowed field of search for trying to identify a change responsible for a reported incident compared with prior solutions. In some embodiments, once the incident manager identifies the responsible change, the incident manager may provide an input to the ITS indicating which change was responsible for the reported incident. In some embodiments, when the ITS receives an input representative of a selected change from among the ranked list of changes responsible for causing the first new incident, the ITS revises the first new incident report to include a reference to the selected change.

In some embodiments, the revised incident report is used to quickly identify responsible code if another incident report is received that is an exact match to the incident report that was linked to the responsible code. Also, the revised incident report may be used to train a machine learning algorithm, so that over time the machine learning algorithm may continue to improve its ability to link incident reports and responsible changes.

In an illustrative embodiment, an ITS receives a new incident report, and responsive to receiving the incident report, the ITS loads data, for example data from a memory for a designated window of time prior to a time associated with the incident report. In some embodiments, the window of time is a predetermined length of time, for example 24 hours or 48 hours extending backwards from the time of the new incident report. In some embodiments, the loaded data includes changes from a change repository and incident reports from an incident repository that occurred during the designate window of time.

In some embodiments, the ITS searches incident data from the change repository for an exact match to the new incident report. For example, in some embodiments, the ITS compares the text description of the new incident report with text descriptions of incident reports from the change repository. In some embodiments, if the ITS finds a matching description, the ITS applies the resolution for new incident report that was already applied for the matching incident report from the change repository. In some embodiments, if the ITS finds a matching description, the ITS reports the match without the need for further processing.

In some embodiments, if the ITS does not find an exact match, the ITS next evaluates the new incident report for matching a repeated incident. In some embodiments, the ITS performs a classification operation on the new incident report to determine if the new incident report is likely to be similar to any resolved incident reports. associated with resolved incidents.

In some embodiments, the ITS includes an algorithm to identify if the new incident report relates to previous incidents about a server, application, or other occurrence to decide if the incident is new or repeated. In some embodiments, the ITS performs a classification operation based on features extracted from both the new incident report and incidents from the incident repository that occurred during a window of time extending back from the time of the new incident report, for example over the past 24 hours, 48 hours, or longer, such as 5 days or one week.

In some embodiments, the ITS extracts features from the new incident report and from the incidents loaded form the incident repository, such as entity values, where an entity refers to an identifier assigned to hardware or software associated with an incident. For example, an entity value may be a server name, designator, or identifier (collectively referred to herein as name for the same of simplicity), a cluster name, or an application name. In some embodiments, the ITS may extract other features, such as text length of the description. In some embodiments, the ITS uses the extracted features to perform a classification operation, for example using a k-nearest neighbor (KNN) algorithm to determine if the new incident report is likely to be similar to any resolved incident reports associated with resolved incidents from the incident repository. In some embodiments, if the ITS finds a similar incident report, the ITS reports the repeated incident and no further processing is needed.

In some embodiments, if the ITS does not find a repeated incident, the ITS performs a second classification operation on the new incident report to generate a ranked list of changes that are likely to be similar to the new incident report. In some embodiments, the ITS applies a stacked ensemble model to generate the ranked list of changes. In some embodiments, the ITS applies the stacked ensemble model to the new incident report and to a set of changes from a change repository. In some embodiments, the set of changes are selected and loaded based on having occurred during a window of time prior to a time associated with the new incident report. For example, in some embodiments, the window of time is a predetermined length of time, such that the set of changes includes only changes that occurred during the past 24 hours, 48 hours, or longer, such as 5 days or one week relative to the time of the new incident report.

In some embodiments, the ITS uses a stacked ensemble model that comprises extracting entity values from the new incident report and from each of the set of changes. In some embodiments, the ITS uses a deep learning model to identify and extract such entity values. In some such embodiments, the extracted entity values include values associated with entities related to the new incident report and/or to the set of changes, for example where an entity refers to an identifier assigned to hardware or software associated with an incident. For example, an entity value may be a server name, designator, or identifier (collectively referred to herein as name for the same of simplicity), a cluster name, or an application name.

Also, or alternatively, in some embodiments, the ITS uses a stacked ensemble model that comprises comparing text of the new incident report and each of the set of changes to generate respective text similarity values. In some embodiments, the ITS uses an unsupervised machine learning model to identify and extract such text similarity values. In some embodiments, the stacked ensemble model includes comparing the text of the new incident report and each of the set of changes by comparing the text at a character level, a word level, and a sentence level.

For example, comparing the text at a character level will reveal text matches where each character of the two text segments are the same, such as a same word or phrase appearing in both the new incident report and one of the set of changes. As another example, comparing the text at a word level will reveal text matches where a word from each of the two text segments are the same or are synonymous, such that a word in the new incident report will be identified that is the same or has the same meaning as a word appearing in one of the set of changes. As another example, comparing the text at a sentence level will reveal text matches where a sentence or phrase from each of the two text segments are the same or are synonymous, such that a sentence or phrase in the new incident report will be identified that is the same or has the same meaning as a sentence or phrase appearing in one of the set of changes.

Also, or alternatively, in some embodiments, the ITS uses a stacked ensemble model that comprises comparing other features of the new incident report and each of the set of changes to generate respective feature similarity values. For example, in some embodiments, the features include a combination of fields available in a dataset, computed features from entity and text components and learned features such as document vectors providing the importance of a given change to the document level representation of any incident and thereby being domain specific and applicable across just a single change incident pair.

In some embodiments, the ITS uses a stacked ensemble model that comprises a classifier that classifies the new incident report based on the extracted entity information, text similarity information, and other features. In some embodiments, the classifier outputs probabilities for each of the set of changes, where each probability represents a probability that the new incident report was caused by the respective change.

In some embodiments, the ITS uses the probabilities from the ensemble classifier to rank each of the set of changes according to how likely each change is responsible for of the incident reported by the new incident report. In some embodiments, the probability values are linked or associated with their respective changes as an indicator of confidence. In some embodiments, the ITS reports the linkage result by outputting the ranked list of changes.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or component that are not shown or described herein, or structures or components different from those shown but for a similar function as described herein may be present without departing the scope of the illustrative embodiments.

Furthermore, the illustrative embodiments are described with respect to specific actual or hypothetical components only as examples. The steps described by the various illustrative embodiments can be adapted for providing explanations for decisions made by a machine-learning classifier model, for example

Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, contrastive explanations, computer readable storage medium, high-level features, historical data, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

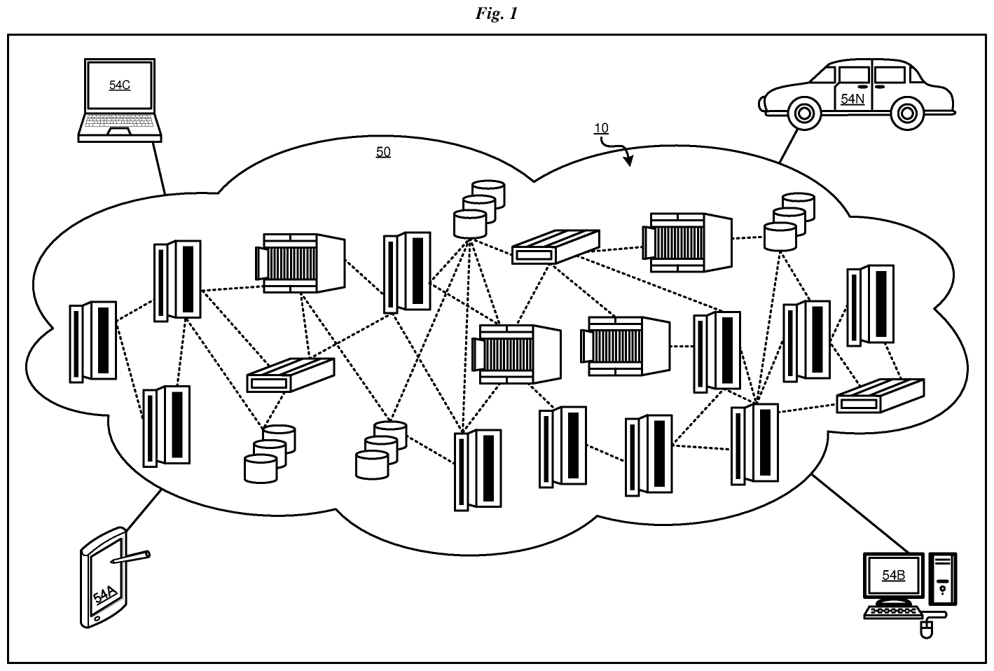

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

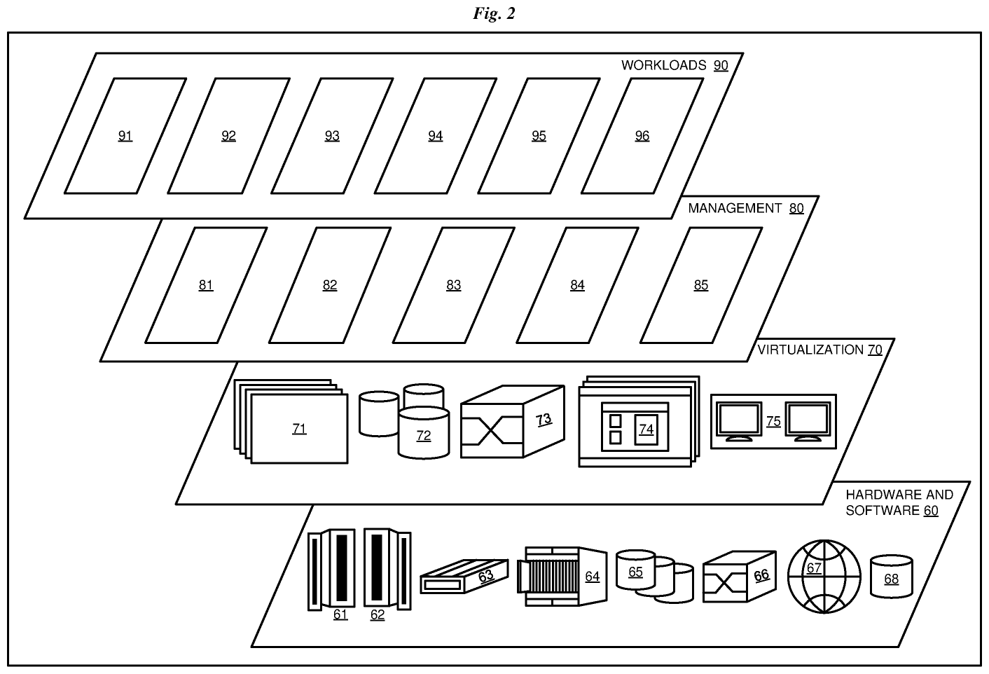

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and ITS processing 96.

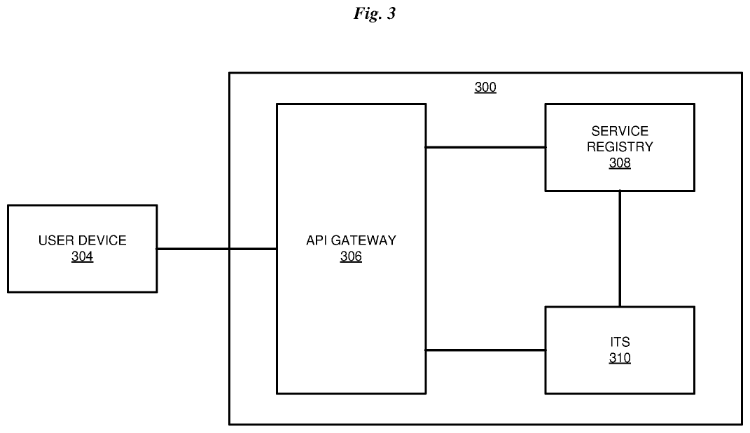

With reference to FIG. 3, this figure depicts a block diagram of an example service infrastructure 300 that includes an ITS 310 in accordance with an illustrative embodiment. In some embodiments, the ITS 310 is deployed in workloads layer 90 of FIG. 2. By way of example, in some embodiments, ITS 310 is implemented as ITS processing 96 in FIG. 2.

In the illustrated embodiment, the service infrastructure 300 provides services and service instances to a user device 304. User device 304 communicates with service infrastructure 300 via an API gateway 306. In various embodiments, service infrastructure 300 and its associated ITS 310 serve multiple users and multiple tenants. A tenant is a group of users (e.g., a company) who share a common access with specific privileges to the software instance. Service infrastructure 300 ensures that tenant specific data is isolated from other tenants.

In some embodiments, user device 304 connects with API gateway 306 via any suitable network or combination of networks such as the Internet, etc. and use any suitable communication protocols such as Wi-Fi, Bluetooth, etc. Service infrastructure 300 may be built on the basis of cloud computing. API gateway 306 provides access to client applications like ITS 310. API gateway 306 receives service requests issued by client applications, and creates service lookup requests based on service requests.

In the illustrated embodiment, service infrastructure 300 includes a service registry 308. In some embodiments, service registry 308 looks up service instances of ITS 310 in response to a service lookup request such as one from API gateway 306 in response to a service request from user device 304. For example, in some embodiments, the service registry 308 looks up service instances of ITS 310 in response to requests related to dubbing and machine translation from the user device 304.

In some embodiments, the service infrastructure 300 includes one or more instances of the ITS 310. In some such embodiments, each of the multiple instances of the ITS 310 run independently on multiple computing systems. In some such embodiments, ITS 310, as well as other service instances of ITS 310, are registered in service registry 308.

In some embodiments, service registry 308 maintains information about the status or health of each service instance including performance information associated each of the service instances. For example, as described in more detail herein, such performance information may include various types of performance characteristics of a given service instance (e.g., cache metrics, etc.). As described in more detail herein, extended service registry 308 ranks service instances based on their respective performance characteristics, and selects top-ranking service instances for service discovery or service lookup requests. In the event that a service instance becomes unresponsive or, unhealthy, the service registry will no longer provide its address or information about this service instance to other services.

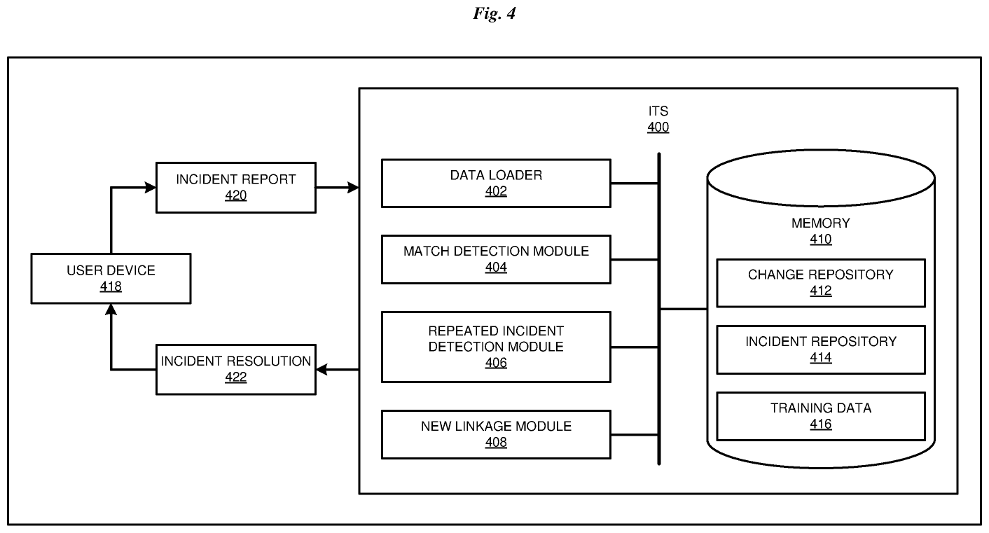

With reference to FIG. 4, this figure depicts a block diagram of an example ITS 400 in accordance with an illustrative embodiment. In a particular embodiment, ITS 400 is deployed as ITS processing 96 in FIG. 2. In a particular embodiment, ITS 400 is an example of ITS 310 of FIG. 3.

In the illustrated embodiment, ITS 400 includes a data loader 402, a match detection module 404, a repeated incident detection module 406, a new linkage module 408, and a memory 410. In the illustrated embodiment, the memory 410 provides data storage, including storage for a change repository 412, an incident repository 414, and training data 416. In alternative embodiments, the ITS 400 can include some or all of the functionality described herein but grouped differently into one or more modules. In some embodiments, the functionality described herein is distributed among a plurality of systems, which can include combinations of software and/or hardware based systems, for example Application-Specific Integrated Circuits (ASICs), computer programs, or smart phone applications.

In the illustrated embodiment, ITS 400 is configured to provide automated and real-time or near-real-time identification of changed-induced incidents. In some embodiments, the ITS 400 is configured to provide real-time, or near-real-time, identification of one or more changes that caused a reported incident so that the change can be corrected and propagation of problems due to the change can be prevented.

In some embodiments, the data loader 402 is configured to detect incoming incident reports, including incident report 420 from user device 418. For example, incident report 420 includes a text description of an unplanned interruption or reduction in quality of an IT service, including a failure of a configuration item that has not yet impacted service. Embodiments of the data loader 402 receive and process incident reports using real-time processing, near-real-time processing, or batch processing. For example, in some embodiments, incident report 420 is received and processed by data loader 402 with little or no significant delay upon being transmitted by user device 418. In some embodiments, data loader 402 receives and/or processes incident reports in batches, for example in batches of incident reports that arrived within a one-minute or five-minute window of time. In some embodiments, upon receiving incident report 420, the data loader 402 loads data from memory 410 for a designated window of time prior to a time associated with the incident report 420. In some embodiments, the window of time is a predetermined length of time, for example 24 hours or 48 hours extending backwards from the time of the incident report 420. In the illustrated embodiment, the data loader 402, loads changes from the change repository 412 and incident reports from the incident repository 414 that occurred during the designate window of time.

In the illustrated embodiment, match detection module 404 is configured for determining if incident report 420 matches any code change ID. For example, in some embodiments, the match detection module 404 searches the text description of the incident report 420 for code change IDs. In some embodiments, if the match detection module 404 finds a code change ID, the ITS 400 stops processing of the incident report 420 rather than continue to the repeated incident detection module 406 and/or new linkage module 408.

In the illustrated embodiment, the repeated incident detection module 406 performs a classification operation on the incident report 420 to determine if the incident report 420 is likely to be similar to any resolved incident reports associated with resolved incidents. In some embodiments, the repeated incident detection module 406 is configured with an algorithm to help identify if the incident report 420 relates to previous incidents about a server, application, or other occurrence to decide if the incident is new or repeated. In some embodiments, the repeated incident detection module 406 performs a classification operation based on features extracted from both the incident report 420 and incidents from the incident repository 414 that occurred during a window of time extending back from the time of the incident report 420, for example over the past 24 hours, 48 hours, or longer, such as 5 days or one week. In some embodiments, the repeated incident detection module 406 extracts features from the incident report 420 and from the incidents loaded form the incident repository 414, such as entity values, where an entity refers to an identifier assigned to hardware or software associated with an incident. For example, an entity value may be a server name, designator, or identifier (collectively referred to herein as name for the same of simplicity), a cluster name, or an application name. In some embodiments, the repeated incident detection module 406 may extract other features, such as text length of the description. In some embodiments, the repeated incident detection module 406 uses the extracted features to perform a classification operation, for example using a k-nearest neighbor (KNN) algorithm to determine if the incident report 420 is likely to be similar to any resolved incident reports associated with resolved incidents from the incident repository 414. In some embodiments, if the repeated incident detection module 406 finds a similar incident report, the ITS 400 stops processing of the incident report 420 rather than continue to the new linkage module 408.

In the illustrated embodiment, the new linkage module 408 performs a second classification operation on the incident report 420 to generate a ranked list of changes that are likely to be similar to the incident report 420. In some embodiments, the new linkage module 408 applies a stacked ensemble model to generate the ranked list of changes. In some embodiments, the new linkage module 408 applies the stacked ensemble model to the incident report 420 and to a set of changes loaded by the data loader 402. In some embodiments, the set of changes are selected and loaded by the data loader 402 based on having occurred during a window of time prior to a time associated with the incident report 420. For example, in some embodiments, the window of time is a predetermined length of time, such that the set of changes includes only changes that occurred during the past 24 hours, 48 hours, or longer, such as 5 days or one week relative to the time of the incident report 420.

In some embodiments, the new linkage module 408 uses a stacked ensemble model that comprises extracting entity values from the incident report 420 and from each of the set of changes. In some embodiments, the new linkage module 408 uses a deep learning model to identify and extract such entity values. In some such embodiments, the extracted entity values are as described with reference to the repeated incident detection module 406, where an entity refers to an identifier assigned to hardware or software associated with an incident. For example, an entity value may be a server name, designator, or identifier (collectively referred to herein as name for the same of simplicity), a cluster name, or an application name.

Also, or alternatively, in some embodiments, the new linkage module 408 uses a stacked ensemble model that comprises comparing text of the incident report 420 and each of the set of changes to generate respective text similarity values. In some embodiments, the new linkage module 408 uses an unsupervised machine learning model to identify and extract such text similarity values. In some embodiments, the stacked ensemble model includes comparing the text of the incident report 420 and each of the set of changes by comparing the text at a character level, a word level, and a sentence level. For example, comparing the text at a character level will reveal text matches where each character of the two text segments are the same, such as a same word or phrase appearing in both the incident report 420 and one of the set of changes. As another example, comparing the text at a word level will reveal text matches where a word from each of the two text segments are the same or are synonymous, such that a word in the incident report 420 will be identified that is the same or has the same meaning as a word appearing in one of the set of changes. As another example, comparing the text at a sentence level will reveal text matches where a sentence or phrase from each of the two text segments are the same or are synonymous, such that a sentence or phrase in the incident report 420 will be identified that is the same or has the same meaning as a sentence or phrase appearing in one of the set of changes.

Also, or alternatively, in some embodiments, the new linkage module 408 uses a stacked ensemble model that comprises comparing other features of the incident report 420 and each of the set of changes to generate respective feature similarity values. For example, in some embodiments, the features include a combination of fields available in a dataset, computed features from entity and text components and learned features such as document vectors providing the importance of a given change to the document level representation of any incident and thereby being domain specific and applicable across just a single change incident pair.

In some embodiments, the new linkage module 408 uses a stacked ensemble model that comprises a classifier that classifies the incident report 420 based on the extracted entity information, text similarity information, and other features. In some embodiments, the classifier outputs probabilities for each of the set of changes, where each probability represents a probability that the incident report 420 was caused by the respective change.

In some embodiments, the new linkage module 408 uses the probabilities from the ensemble classifier to rank each of the set of changes according to how likely each change is responsible for the incident reported by the incident report 420. In some embodiments, the probability values are linked or associated with their respective changes as an indicator of confidence. In some embodiments, the new linkage module 408 outputs the ranked list of changes as incident resolution 422 to an incident manager for evaluation. The embodiment also includes receiving an input representative of a selected change from among the ranked list of changes to an incident manager or the like for review to determine the change responsible for causing the incident associated with the incident report 420. In some embodiments, the ranked list includes less than all of the set of changes. For example, in some embodiments, the output list is limited to a predetermined number of changes. In some embodiments, the ITS 400 receives an input from the incident manager representative of a selected change from among the ranked list of changes responsible for causing the first new incident. In some embodiments, the ITS 400 revises the incident report 420 to include a reference to the selected change.

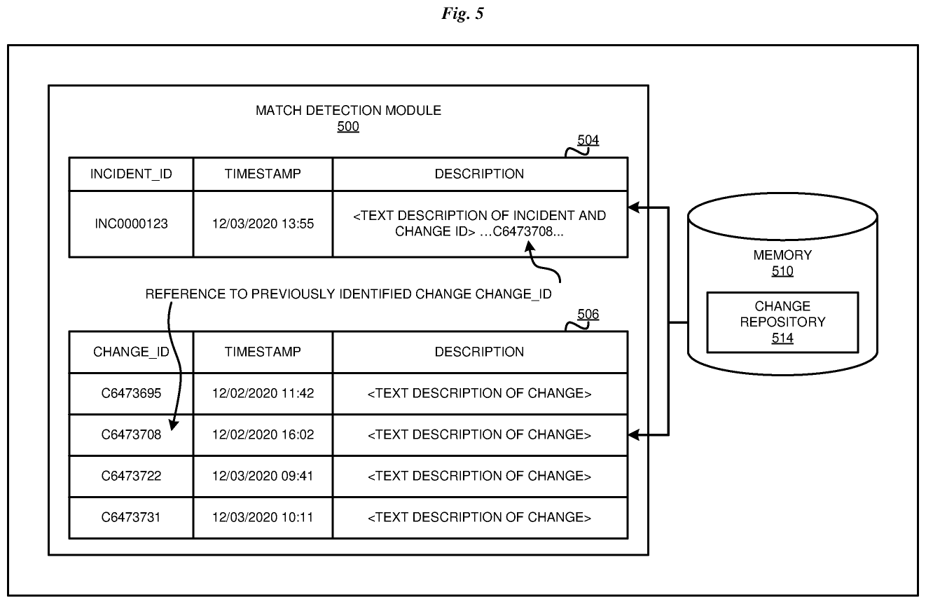

With reference to FIG. 5, this figure depicts a block diagram of an example operation by the match detection module 500 in accordance with an illustrative embodiment. In a particular embodiment, match detection module 500 an example of match detection module 404 of FIG. 4 and incident report 504 is an example of incident report 420 of FIG. 4.

In the illustrated embodiment, match detection module 500 is configured for determining if incident report 504 matches any code change ID. For example, in some embodiments, the match detection module 500 searches the text description of an incident report 504 for code change IDs. In a particular embodiment, the memory 510, where change repository 514 is stored, is an example of memory 410 of FIG. 4.

In the illustrated embodiment, incident data from incident report 504 includes a text description that includes a code change ID that matches a code change ID from among a set of changes 506. In the illustrated example, the incident report 504 includes data associated with a change, where the incident was resolved by determining that the incident was caused by the particular change (e.g., Change_ID C6473708 in the illustrated example) from among a set of changes 506. As a result, the Change_ID of the responsible change was added to the description of the incident report 504. This allows the match detection module 500 to quickly determine that the code is responsible for the incident report 504 and no further processing is needed.

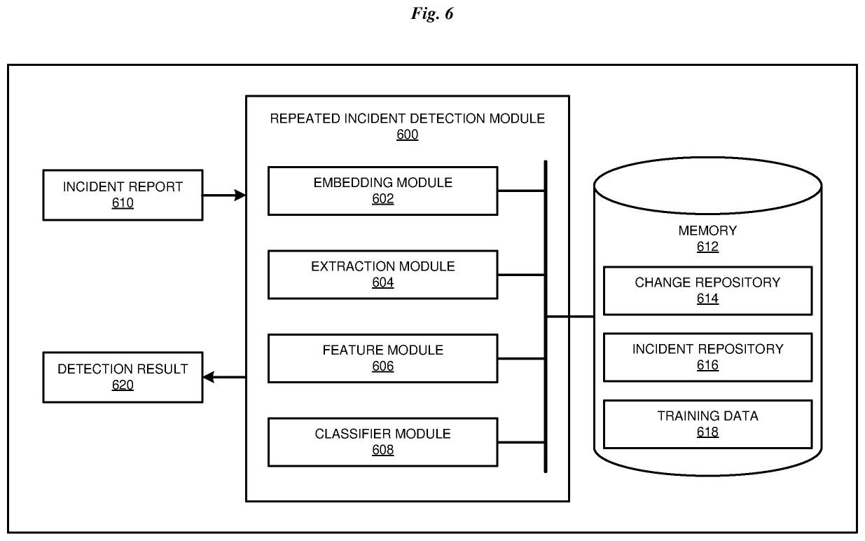

With reference to FIG. 6, this figure depicts a block diagram of an example repeated incident detection module 600 in accordance with an illustrative embodiment. In a particular embodiment, repeated incident detection module 600 is an example of repeated incident detection module 406 of FIG. 4 and incident report 610 is an example of incident report 420 of FIG. 4.

In the illustrated embodiment, repeated incident detection module 600 includes an embedding module 602, extraction module 604, feature module 606, and classifier module 608. In alternative embodiments, the repeated incident detection module 600 can include some or all of the functionality described herein but grouped differently into one or more modules. In some embodiments, the functionality described herein is distributed among a plurality of systems, which can include combinations of software and/or hardware based systems, for example Application-Specific Integrated Circuits (ASICs), computer programs, or smart phone applications. In the illustrated embodiment, the embedding module 602, extraction module 604, feature module 606, and classifier module 608 are in communication with memory 612. In the illustrated embodiment, the memory 612 provides data storage, including storage for a change repository 614, an incident repository 616, and training data 618. In a particular embodiment, the memory 612 is an example of memory 410 of FIG. 4.

In the illustrated embodiment, the repeated incident detection module 600 performs a classification operation on the incident report 610 to determine if the incident report 610 is likely to be similar to any resolved incident reports associated with resolved incidents from the incident repository 616. In some embodiments, the repeated incident detection module 600 is configured with an algorithm to help identify if the incident report 610 relates to previous incidents about a server, application, or other occurrence to decide if the incident is new or repeated. In some embodiments, the repeated incident detection module 600 includes a classifier module 608 that performs a classification operation based on features extracted from both the incident report 610 and incidents from the incident repository 616 that occurred during a window of time extending back from the time of the incident report 610, for example over the past 24 hours, 48 hours, or longer, such as 5 days or one week.

In the illustrated embodiment, the repeated incident detection module 600 includes an embedding module 602 for preparing the text from the incident report 610 and from the incidents from the incident repository 616 for processing by the classifier module 608. In the illustrated embodiment, embedding module 602 generates vector representations of text from the incident report 610, including entities and features extracted by the extraction module 604 and feature module 606. In some embodiments, the vector representation is generated according to an embedding function. The embedding function is configured to “project” keyword units in a vector space as word vectors in which distances between the word vectors in the vector space correspond to semantic similarities between the keyword units. For example, in some embodiments, word vectors are generated using the fastText word embedding function.

In the illustrated embodiment, the extraction module 604 extracts entity values from the incident report 610 and from the incidents loaded form the incident repository 616, such as entity values, where an entity refers to an identifier assigned to hardware or software associated with an incident. For example, an entity value may be a server name, designator, or identifier (collectively referred to herein as name for the same of simplicity), a cluster name, or an application name. In the illustrated embodiment, the feature module 606 extracts other features, such as text length of the description, from the incident report 610 and from the incidents loaded form the incident repository 616.

In some embodiments, the classifier module 608 uses the extracted entities and features to perform a classification operation. For example, in some embodiments, the classifier module 608 uses a k-nearest neighbor (KNN) algorithm to determine if the incident report 610 is likely to be similar to any resolved incident reports associated with resolved incidents from the incident repository 614. In some embodiments, if the repeated incident detection module 600 finds a similar incident report, the repeated incident detection module 600 generates an detection result 620 indicating the result of the processing, including an indication of the incident report from the repository 614 that is similar to the incident report 610, for example in a format that may be reviewed by an incident manager.

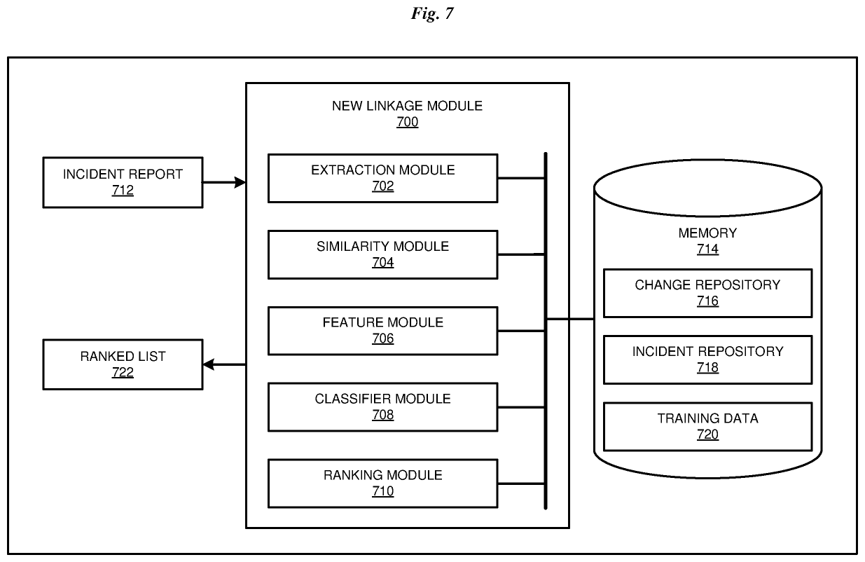

With reference to FIG. 7, this figure depicts a block diagram of an example new linkage module 700 in accordance with an illustrative embodiment. In a particular embodiment, new linkage module 700 is an example of new linkage module 408 of FIG. 4 and incident report 712 is an example of incident report 420 of FIG. 4.

In the illustrated embodiment, new linkage module 700 includes an extraction module 702, similarity module 704, feature module 706, classifier module 708, and ranking module 710. In alternative embodiments, the new linkage module 700 can include some or all of the functionality described herein but grouped differently into one or more modules. In some embodiments, the functionality described herein is distributed among a plurality of systems, which can include combinations of software and/or hardware based systems, for example Application-Specific Integrated Circuits (ASICs), computer programs, or smart phone applications. In the illustrated embodiment, the extraction module 702, similarity module 704, feature module 706, classifier module 708, and ranking module 710 are in communication with memory 714. In the illustrated embodiment, the memory 714 provides data storage, including storage for a change repository 716, an incident repository 718, and training data 720. In a particular embodiment, the memory 714 is an example of memory 410 of FIG. 4.

In the illustrated embodiment, the new linkage module 700 performs a second classification operation on the incident report 712 to generate a ranked list of changes that are likely to be similar to the incident report 712. In some embodiments, the new linkage module 700 applies a stacked ensemble model to generate the ranked list of changes. In some embodiments, the new linkage module 700 applies the stacked ensemble model to the incident report 712 and to a set of changes from the repository 716. In some embodiments, the set of changes are selected based on having occurred during a window of time prior to a time associated with the incident report 712. For example, in some embodiments, the window of time is a predetermined length of time, such that the set of changes includes only changes that occurred during the past 24 hours, 48 hours, or longer, such as 5 days or one week relative to the time of the incident report 712.

In some embodiments, the extraction module 702 uses a stacked ensemble model that comprises extracting entity values from the incident report 712 and from each of the set of changes. In some embodiments, the extraction module 702 uses a deep learning model to identify and extract such entity values. In some such embodiments, the extracted entity values include values associated with entities related to the incident report 712 and/or to the set of changes, for example where an entity refers to an identifier assigned to hardware or software associated with an incident. For example, an entity value may be a server name, designator, or identifier (collectively referred to herein as name for the same of simplicity), a cluster name, or an application name.

Also, or alternatively, in some embodiments, the new linkage module 700 uses a similarity module 704 that compares text of the incident report 712 and each of the set of changes from repository 716 to generate respective text similarity values. In some embodiments, the similarity module 704 uses an unsupervised machine learning model to identify and extract such text similarity values. In some embodiments, the similarity module 704 compares the text of the incident report 712 and each of the set of changes by comparing the text at a character level, a word level, and a sentence level. For example, comparing the text at a character level will reveal text matches where each character of the two text segments are the same, such as a same word or phrase appearing in both the incident report 712 and one of the set of changes. As another example, comparing the text at a word level will reveal text matches where a word from each of the two text segments are the same or are synonymous, such that a word in the incident report 712 will be identified that is the same or has the same meaning as a word appearing in one of the set of changes. As another example, comparing the text at a sentence level will reveal text matches where a sentence or phrase from each of the two text segments are the same or are synonymous, such that a sentence or phrase in the incident report 712 will be identified that is the same or has the same meaning as a sentence or phrase appearing in one of the set of changes.

Also, or alternatively, in some embodiments, the new linkage module 700 uses feature module 706 that compares other features of the incident report 712 and each of the set of changes to generate respective feature similarity values. For example, in some embodiments, the features include a combination of fields available in a dataset, computed features from entity and text components and learned features such as document vectors providing the importance of a given change to the document level representation of any incident and thereby being domain specific and applicable across just a single change incident pair.

In some embodiments, the new linkage module 700 uses a classifier module 708 that classifies the incident report 712 based on the extracted entity information, text similarity information, and other features. In some embodiments, the classifier module 708 outputs probabilities for each of the set of changes, where each probability represents a probability that the incident report 712 was caused by the respective change.

In some embodiments, the new linkage module 700 uses a ranking module 710 to generate a ranked list 722 in which each of the set of changes is ranked according to how likely each change is responsible for the incident reported by the incident report 712. In some embodiments, the ranking module 710 uses the probabilities from the classifier module 708 to rank each of the set of changes. In some embodiments, the probability values are linked or associated with their respective changes as an indicator of confidence. In some embodiments, the new linkage module 700 outputs the ranked list 722 of changes to an incident manager for evaluation. The embodiment also includes receiving an input representative of a selected change from among the ranked list of changes to an incident manager or the like for review to determine the change responsible for causing the incident associated with the incident report 712. In some embodiments, the ranked list includes less than all of the set of changes. For example, in some embodiments, the output list is limited to a predetermined number of changes.

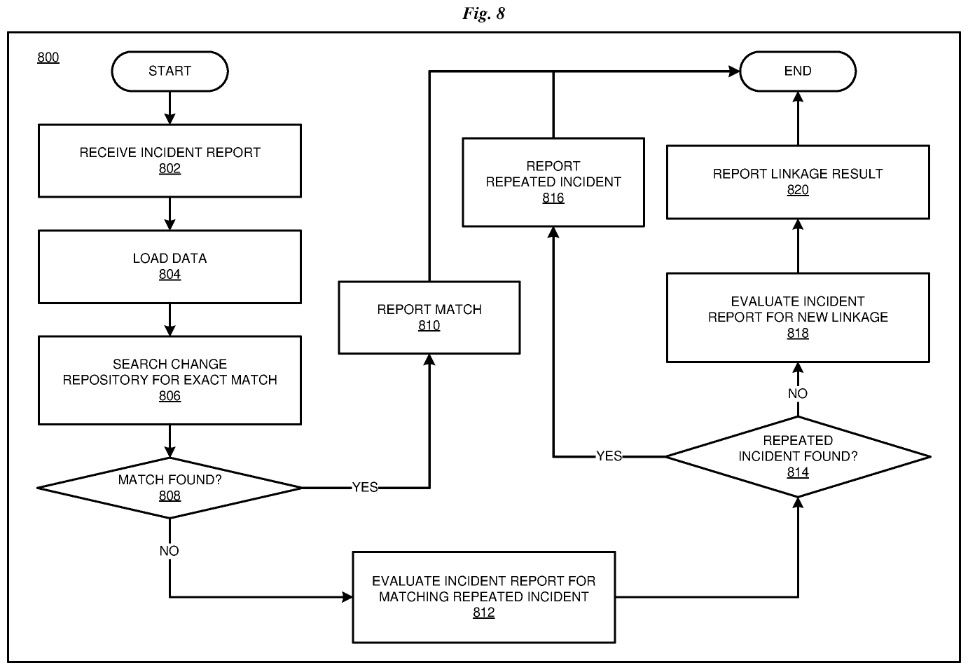

With reference to FIG. 8 this figure depicts a flowchart of an example process 800 for providing automated identification of changed-induced incidents in accordance with an illustrative embodiment. In a particular embodiment, the ITS 400 carries out the process 800.

In an embodiment, at block 802, the process receives a new incident report. In an embodiment, at block 804, the process loads data, for example data from a memory for a designated window of time prior to a time associated with the incident report. In some embodiments, the window of time is a predetermined length of time, for example 24 hours or 48 hours extending backwards from the time of the new incident report. In the illustrated embodiment, the loaded data includes changes from a change repository and incident reports from an incident repository that occurred during the designate window of time.

In an embodiment, at block 806, the process searches incident data from the change repository for an exact match to the new incident report. For example, in some embodiments, the process searches the text description of the incident report for code change IDs. In some embodiments, at block 808 if the process finds a code change ID (indicative of finding an exact match), the process reports the match at block 810 and ends.

If no match is found at block 808, the process continues to block 812. In an embodiment, at block 812, the process evaluates the new incident report for matching a repeated incident. In some embodiments, the process performs a classification operation on the new incident report to determine if the new incident report is likely to be similar to any resolved incident reports associated with resolved incidents. In some embodiments, the process includes an algorithm to identify if the new incident report relates to previous incidents about a server, application, or other occurrence to decide if the incident is new or repeated. In some embodiments, the process performs a classification operation based on features extracted from both the new incident report and incidents from the incident repository that occurred during a window of time extending back from the time of the new incident report, for example over the past 24 hours, 48 hours, or longer, such as 5 days or one week. In some embodiments, the process extracts features from the new incident report and from the incidents loaded form the incident repository, such as entity values, where an entity refers to an identifier assigned to hardware or software associated with an incident. For example, an entity value may be a server name, designator, or identifier (collectively referred to herein as name for the same of simplicity), a cluster name, or an application name. In some embodiments, the process may extract other features, such as text length of the description. In some embodiments, the process uses the extracted features to perform a classification operation, for example using a k-nearest neighbor (KNN) algorithm to determine if the new incident report is likely to be similar to any resolved incident reports associated with resolved incidents from the incident repository. In some embodiments, at block 814, if the process finds a similar incident report, the process reports the repeated incident at block 816 and ends.

If no repeated incident is found at block 814, the process continues to block 818. In an embodiment, at block 818, the process performs a second classification operation on the new incident report to generate a ranked list of changes that are likely to be similar to the new incident report. In some embodiments, the process applies a stacked ensemble model to generate the ranked list of changes. In some embodiments, the process applies the stacked ensemble model to the new incident report and to a set of changes from a change repository. In some embodiments, the set of changes are selected and loaded based on having occurred during a window of time prior to a time associated with the new incident report. For example, in some embodiments, the window of time is a predetermined length of time, such that the set of changes includes only changes that occurred during the past 24 hours, 48 hours, or longer, such as 5 days or one week relative to the time of the new incident report.

In some embodiments, the process uses a stacked ensemble model that comprises extracting entity values from the new incident report and from each of the set of changes. In some embodiments, the process uses a deep learning model to identify and extract such entity values. In some such embodiments, the extracted entity values include values associated with entities related to the new incident report and/or to the set of changes, for example where an entity refers to an identifier assigned to hardware or software associated with an incident. For example, an entity value may be a server name, designator, or identifier (collectively referred to herein as name for the same of simplicity), a cluster name, or an application name.

Also, or alternatively, in some embodiments, the process uses a stacked ensemble model that comprises comparing text of the new incident report and each of the set of changes to generate respective text similarity values. In some embodiments, the process uses an unsupervised machine learning model to identify and extract such text similarity values. In some embodiments, the stacked ensemble model includes comparing the text of the new incident report and each of the set of changes by comparing the text at a character level, a word level, and a sentence level. For example, comparing the text at a character level will reveal text matches where each character of the two text segments are the same, such as a same word or phrase appearing in both the new incident report and one of the set of changes. As another example, comparing the text at a word level will reveal text matches where a word from each of the two text segments are the same or are synonymous, such that a word in the new incident report will be identified that is the same or has the same meaning as a word appearing in one of the set of changes. As another example, comparing the text at a sentence level will reveal text matches where a sentence or phrase from each of the two text segments are the same or are synonymous, such that a sentence or phrase in the new incident report will be identified that is the same or has the same meaning as a sentence or phrase appearing in one of the set of changes.

Also, or alternatively, in some embodiments, the process uses a stacked ensemble model that comprises comparing other features of the new incident report and each of the set of changes to generate respective feature similarity values. For example, in some embodiments, the features include a combination of fields available in a dataset, computed features from entity and text components and learned features such as document vectors providing the importance of a given change to the document level representation of any incident and thereby being domain specific and applicable across just a single change incident pair.

In some embodiments, the process uses a stacked ensemble model that comprises a classifier that classifies the new incident report based on the extracted entity information, text similarity information, and other features. In some embodiments, the classifier outputs probabilities for each of the set of changes, where each probability represents a probability that the new incident report was caused by the respective change.

In some embodiments, the process uses the probabilities from the ensemble classifier to rank each of the set of changes according to how likely each change is responsible for of the incident reported by the new incident report. In some embodiments, the probability values are linked or associated with their respective changes as an indicator of confidence. In some embodiments, at block 820, the process reports the linkage result by outputting the ranked list of changes, and the process ends.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
determining if a first new incident report of a first new incident matches any resolved incident reports associated with resolved incidents;
performing a first classification operation on the first new incident report to determine if the first new incident report is likely to be similar to any resolved incident reports associated with resolved incidents;
performing a second classification operation on the first new incident report to generate a ranked list of changes that are likely to be similar to the first new incident report;
outputting the ranked list of changes to an incident manager for evaluation;
receiving an input representative of a selected change from among the ranked list of changes responsible for causing the first new incident; and
revising the first new incident report to include a reference to the selected change.

2. The computer-implemented method of claim 1, further comprising:
generating a notification regarding the selected change causing the first new incident.

3. The computer-implemented method of claim 1, further comprising:
determining if a second new incident report of a second new incident matches any resolved incident reports associated with resolved incidents; and
revising, responsive to determining that the second new incident report matches the first new incident report, the second new incident report to include the reference to the selected change.

4. The computer-implemented method of claim 1, wherein the performing of the first classification operation on the first new incident report comprises applying a k-nearest neighbor algorithm to determine if the first new incident report is likely to be similar to any resolved incident reports associated with resolved incidents.

5. The computer-implemented method of claim 1, wherein the performing of the second classification operation on the first new incident report comprises applying a stacked ensemble model to generate the ranked list of changes.

6. The computer-implemented method of claim 5, wherein the applying of the stacked ensemble model comprises applying the stacked ensemble model to the first new incident report and a set of changes.

7. The computer-implemented method of claim 6, further comprising selecting the set of changes based on determining which changes occurred during a window of time prior to a time associated with the first new incident report.

8. The computer-implemented method of claim 7, wherein the window of time is a predetermined length of time.

9. The computer-implemented method of claim 6, wherein the applying of the stacked ensemble model comprises extracting entity values from the first new incident report and from each of the set of changes.

10. The computer-implemented method of claim 6, wherein the applying of the stacked ensemble model comprises comparing text of the first new incident report and each of the set of changes to generate respective text similarity values.

11. The computer-implemented method of claim 10, wherein the comparing of the text of the first new incident report and each of the set of changes comprises comparing the text at a character level, a word level, and a sentence level.

12. A computer program product comprising one or more computer readable storage media, and program instructions collectively stored on the one or more computer readable storage media, the program instructions executable by a processor to cause the processor to perform operations comprising:
determining if a first new incident report of a first new incident matches any resolved incident reports associated with resolved incidents;
performing a first classification operation on the first new incident report to determine if the first new incident report is likely to be similar to any resolved incident reports associated with resolved incidents;
performing a second classification operation on the first new incident report to generate a ranked list of changes that are likely to be similar to the first new incident report;
outputting the ranked list of changes to an incident manager for evaluation;
receiving an input representative of a selected change from among the ranked list of changes responsible for causing the first new incident; and
revising the first new incident report to include a reference to the selected change.

13. The computer program product of claim 12, wherein the stored program instructions are stored in a computer readable storage device in a data processing system, and wherein the stored program instructions are transferred over a network from a remote data processing system.

14. The computer program product of claim 12, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

15. The computer program product of claim 12, further comprising:
generating a notification regarding the selected change causing the first new incident.

16. The computer program product of claim 12, further comprising:
determining if a second new incident report of a second new incident matches any resolved incident reports associated with resolved incidents; and
revising, responsive to determining that the second new incident report matches the first new incident report, the second new incident report to include the reference to the selected change.

17. The computer program product of claim 12, wherein the performing of the first classification operation on the first new incident report comprises applying a k-nearest neighbor algorithm to determine if the first new incident report is likely to be similar to any resolved incident reports associated with resolved incidents.

18. A computer system comprising a processor and one or more computer readable storage media, and program instructions collectively stored on the one or more computer readable storage media, the program instructions executable by the processor to cause the processor to perform operations comprising:
determining if a first new incident report of a first new incident matches any resolved incident reports associated with resolved incidents;
performing a first classification operation on the first new incident report to determine if the first new incident report is likely to be similar to any resolved incident reports associated with resolved incidents;
performing a second classification operation on the first new incident report to generate a ranked list of changes that are likely to be similar to the first new incident report;
outputting the ranked list of changes to an incident manager for evaluation;
receiving an input representative of a selected change from among the ranked list of changes responsible for causing the first new incident; and
revising the first new incident report to include a reference to the selected change.

19. The computer system of claim 18, further comprising:
generating a notification regarding the selected change causing the first new incident.

20. The computer system of claim 18, further comprising:
determining if a second new incident report of a second new incident matches any resolved incident reports associated with resolved incidents; and
revising, responsive to determining that the second new incident report matches the first new incident report, the second new incident report to include the reference to the selected change.
